(19) United States
(12) Patent Application Publication
(10) Pub. No.: US 2010/0095525 A1
(43) Pub. Date: Apr. 22, 2010

(54) GAS TURBINE COMBUSTOR REPAIR USING A MAKE-UP RING

(76) Inventor: Alan Terence SHAW, Brossard (CA)

Correspondence Address: OGILVY RENAULT LLP (PWC), 1, PLACE VILLE MARIE, SUITE 2500, MONTREAL, QC, H3B 1R1, CA

(21) Appl. No.: 12/255,973

(22) Filed: Oct. 22, 2008

(51) Int. Cl. B23P 6/00

(52) U.S. Cl. 29/888.021

(57) ABSTRACT

A method of repairing a one-piece annular combustor of a gas turbine engine includes cutting through the combustor liner to separate the combustor into two pieces, repairing the combustor as desired, and then closing the combustor by using a make-up ring, which may be welded in place between the two pieces of the combustor. The make-up ring may be provided with an axial length selected such that an overall length of the combustor after the repair process is substantially equal to an initial overall length of the combustor before the repair.

### TECHNICAL FIELD

The field relates generally to gas turbine engine combustors and methods of repairing same.

### BACKGROUND

Gas turbine engine combustors constructed of “one piece” liners have been developed in order to reduce weight and manufacturing costs. See, for example, U.S. Pat. Nos. 7,308,794 and 7,350,358, the entire specifications of which are incorporated herein by reference. If access to the internals of the combustor is required for weld repairs and/or coating restoration, etc., access to the interior of such one piece combustor liners is obtained by cutting in order to permit access. However, one faces problems as to how to reassemble the liner, without undesirable material losses, in order to restore it to serviceable condition.

### SUMMARY

There is provided a method of repairing a one-piece annular reverse-flow combustor of a gas turbine engine, the combustor including a combustor liner having a sheet of metal contiguously defining an inner liner wall extending to a dome wall extending to an outer liner wall, the dome wall provided at an upstream end of the combustor relative to an airflow through the liner, the inner and outer liner walls extending from the dome to a liner exit at a downstream end of the combustor, the method comprising: opening the combustor by cutting through and around a circumference of at least one of the inner and outer liner walls of the combustor liner to separate the combustor into at least two pieces thereby exposing an internal surface of the combustor, each of the at least two pieces having a cut edge made by said cut; performing at least one repair operation on the combustor; and closing the combustor by joining the at least two pieces together, the step of closing including the steps of: providing an annular sheet metal ring having a size and shape corresponding to the combustor liner in a region of the cut, the ring is provided with a length between first and second ring ends; welding the first end of the ring to a first one of the at least two combustor pieces the respective cut edge; and welding the second end of the ring to the other of the at least two combustor pieces at the respective cut edge; wherein the make-up ring is provided with a length between the first and second ends sufficient to provide the combustor with a desired length after the step of closing is completed.

There is also provided a method of re-establishing original dimensional characteristics of a one-piece annular gas turbine combustor that has been cut into at least two combustor portions for repair purposes, the method comprising the steps of: providing an annular make-up ring having a size and shape corresponding to the combustor liner; welding a first end of the make-up ring to a first one of the two combustor portions at a location of the cut made therein; ensuring the make-up ring has a predetermined axial length between said first end and a second end of the make-up ring; and welding the second end of the make-up ring to the other one of the two combustor pieces at the location of the cut made therein; and wherein the predetermined axial length of the make-up ring is selected such that an overall axial length of the combustor after the step of welding the second end of the make-up ring to the combustor liner is substantially equal to an original overall length of the combustor before the repair.

Further details will be apparent from the detailed description and figures included below.

### DESCRIPTION OF THE DRAWINGS

Reference is now made to the accompanying figures, in which:

FIG. 1 shows a schematic cross-section of a gas turbine engine;

FIG. 2 shows a schematic cross-section of an annular reverse flow combustor of the engine of FIG. 1;

FIG. 3 is a partial cross-sectional view of the combustor of FIG. 2, wherein the inner and outer combustor liners have been cut away from the dome portion to disassemble the combustor during repair as per the present method;

FIG. 4 is a partial cross-sectional view of a portion of the disassembled combustor of FIG. 3, having a make-up ring attached thereto;

FIG. 5 is a partial cross-sectional view of the portion of the disassembled combustor of FIG. 4, re-attached to the dome portion thereby re-assembling the combustor; and

FIG. 6 is a schematic cross-section of the annular reverse flow combustor of FIG. 2, repaired in accordance with the steps shown in FIGS. 3-5.

### DETAILED DESCRIPTION

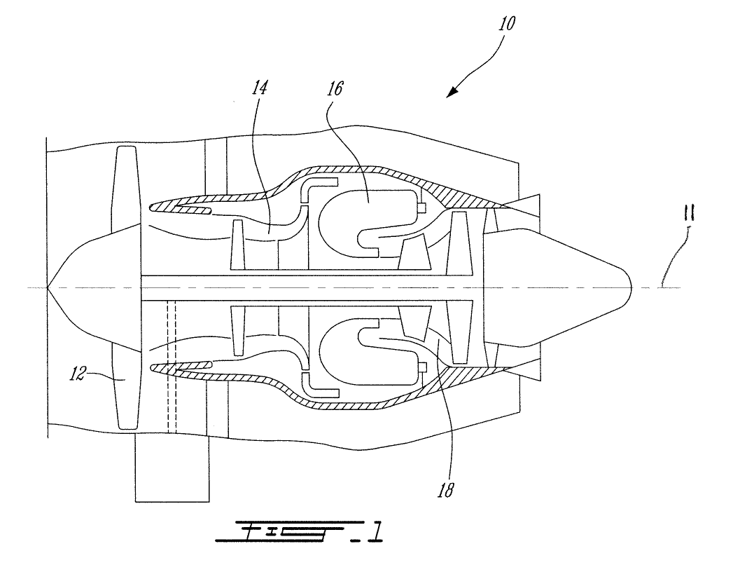

FIG. 1 illustrates a gas turbine engine 10 of a type preferably provided for use in subsonic flight, generally comprising in serial flow communication a fan 12 through which ambient air is propelled, a multistage compressor 14 for pressurizing the air, an annular reverse flow combustor 16 in which the compressed air is mixed with fuel and ignited for generating an annular stream of hot combustion gases, and a turbine section 18 for extracting energy from the combustion gases.

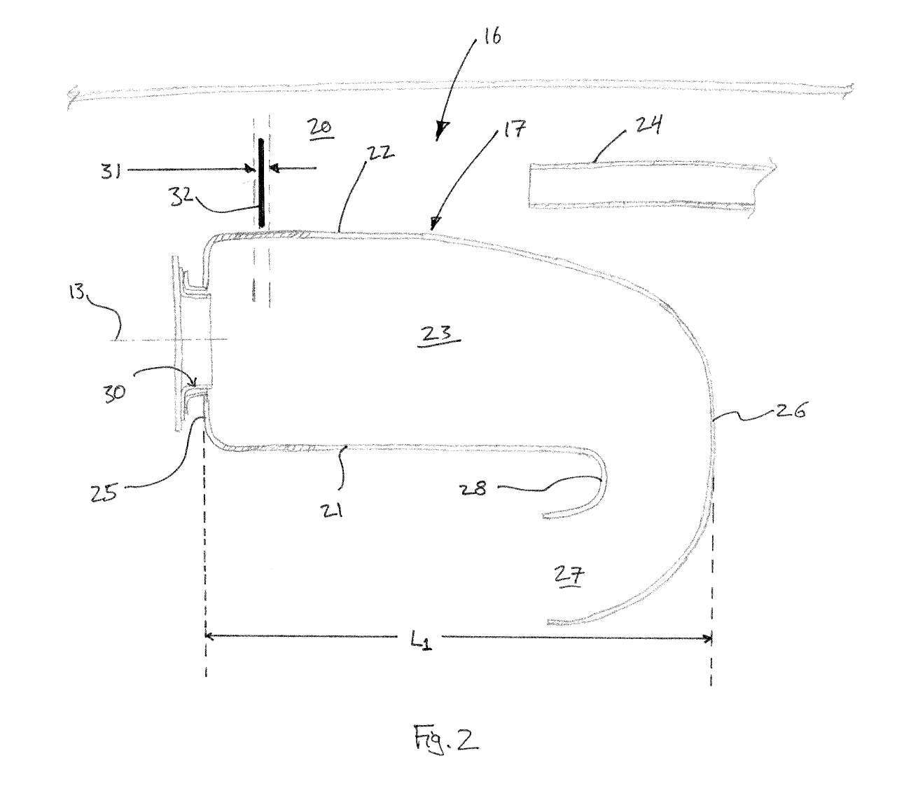

Referring to FIG. 2, the annular reverse flow combustor 16 comprises generally a combustor liner 17, having an inner liner portion 21 and an outer liner portion 22 defining a combustion chamber 23 therebetween. The inner and outer liners portions 21 and 22 of the combustor liner 17 are, in at least one possible embodiment, comprised of a single ply of sheet metal. Outer liner 22 includes a long exit duct portion 26, while inner liner 21 includes a small exit duct portion 28, both leading to a combustor exit 27 in fluid flow communication with the downstream turbine section. A fuel nozzle is received within each of the fuel nozzle openings 30 in the dome portion 25, the fuel nozzle communicating with the combustion chamber 23 to inject fuel and/or a fuel-air mixture therein. An air plenum 20, which surrounds the combustor liner 17, receives compressed air from the compressor section 14 of the gas turbine engine 10, via the diffuser pipes 24. In use, compressed air from plenum 20 enters combustion chamber 23 through a plurality of holes (not shown) defined through the combustor liner 17 and is ignited and fuelled by fuel injected into the combustion chamber 23 by the fuel nozzles. Hot combusted gases within the combustion chamber 23 are directed through the reverse flow combustor, which redirects the flow towards the combustor exit 27 before being fed to the turbine stage downstream of the combustor.

As noted above, one piece combustor liners must be disassembled by cutting them into at least two pieces to allow access to the internals for weld repairs and/or coating restoration on the internal gas path surfaces. Careful positioning of the cut (ex: along cut line 32 in the combustor liner 17) will at least limit the loss/damage of the original cooling holes in the combustor liner walls. However, such a cut in the combustor wall, even when made using a laser, nonetheless results in a certain amount of material loss at the cut site corresponding to the width of the laser beam (depicted by the gap width 31 of the cut shown in FIG. 2). The combined material losses (i.e. the width of the laser beam and the weld shrinkage which occurs when the two parts are re-welded together), can be as much as approximately 0.04 inches (0.1016 cm) in length.

As such, the present method employs the addition of a so-called “make-up” ring, which is added to the combustor liner when being closed back up (i.e. after have been cut open for repair purposes), in order return the dimensional characteristics of the liner to their original state, and more particularly in order to restore the combustor to its original length.

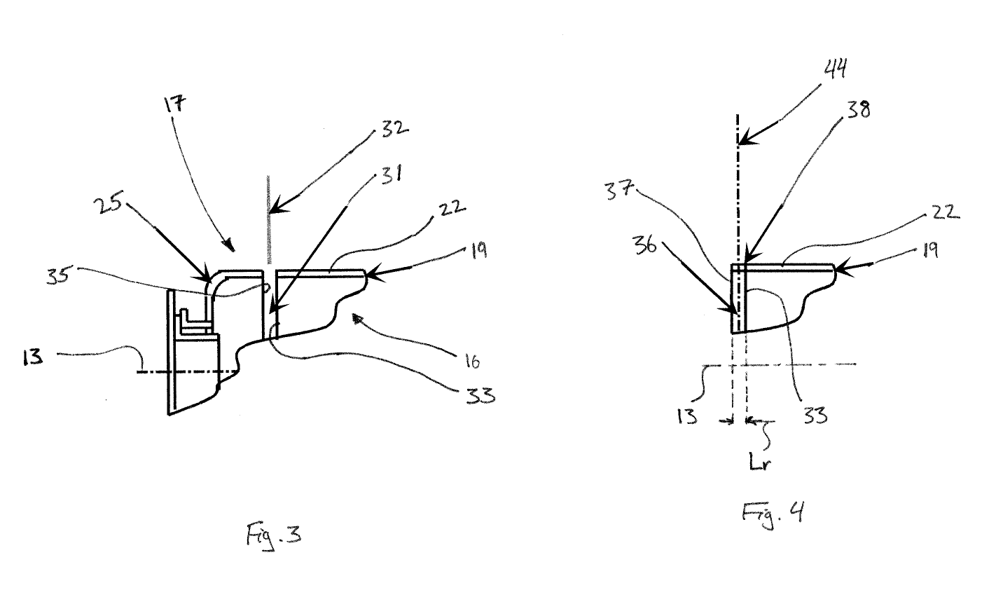

Accordingly, as shown in FIGS. 3-5, the present method first includes the step of disassembling the combustor 16 by cutting open the one-piece combustor liner 17. This is done by making a cut through at least one of the inner and outer liner walls along cut line 32, creating downstream cut edge 33 on the liner wall portion 19 of the combustor and an upstream cut edge 35 on the dome portion 25 of the combustor. Although in the depicted embodiment only the outer liner wall 22 is cut, thereby separating the annular reverse-flow combustor 16 into two portions, it is also possible to make two or more such cuts, if desired for example in order to better access internal surfaces of the combustor, thereby separating the combustor into three or more pieces rather than only two. As such, the step of cutting the combustor liner 17 will be further described with reference to a single cut made in only the outer liner wall 22, however one or both of the inner and outer liner walls can of course be similarly cut and subsequently re-closed using the make-up ring 36 described herein. It is to be understood that, if both the inner and outer liner walls are cut, two such make-up rings are required in order to close the combustor back up, namely one make-up ring 36 to rejoin the cut portions of the outer liner together and another make-up ring 36 to rejoin the cut portions of the inner liner together.

Making the cut along cut line 32 in the outer liner wall 22 separates the combustor 16 into two parts (namely the liner wall portion 19 and the dome portion 25), thereby creating the cut gap 31 between the now separated dome portion 25 and the liner wall portion 19 of the combustor liner 17. Once the combustor has been opened, thereby providing access to the its internal surfaces, the necessary repair of the combustor is carried out. Such repairs can include, but are not limited to, weld repairs, coating restoration and/or repair of cracking of the liner walls.

Once the necessary repairs to the combustor have been carried out, the combustor can be re-assembled. This is achieved using the following steps.

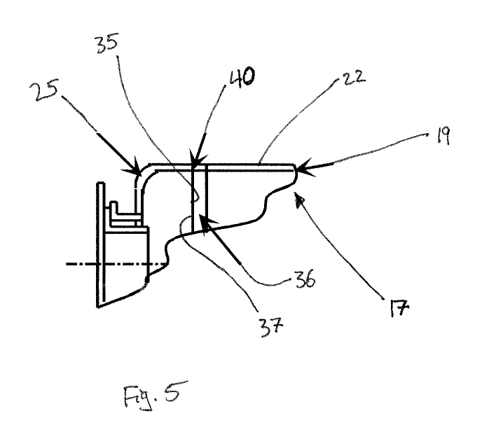

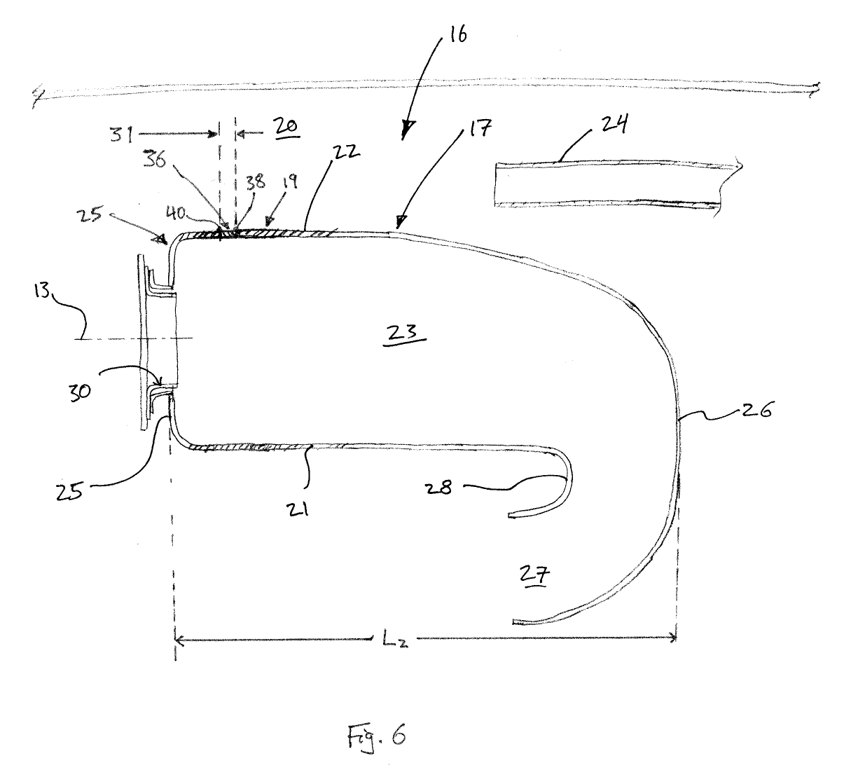

As shown in FIGS. 4 and 5, a make-up ring 36 is attached, such as by welding, between the two portions of the combustor. This can be done in any order, however in the depicted case, the make-up ring 36 is first attached by a first annular weld 38, as shown in FIG. 4, to the downstream cut edge 33 of the downstream liner wall portion 19 of the disassembled combustor. Once the make-up ring 36 is in place on the first of the two combustor portions, and it is determined that the axial length of the make-up ring 36 corresponds to the desired length (as described in further detail below), the other of the two combustor portions is then welded to the opposite end of the make-up ring 36 to thereby enclose the combustor, as shown in FIG. 5. In the depicted embodiment, this is done by making a second annular butt weld 40 between the upstream cut edge 35 of the combustor dome portion 25 and the free end 37 of the annular make-up ring 36.

The make-up ring 36 is preferably an annular sheet metal ring which substantially corresponds in size, shape and material properties (ex: strength, thermal expansion coefficient, etc.) to the combustor liner walls to which it is attached. Although other materials can be used, in at least on embodiment the make-up ring 36 is also made of the same material as the sheet metal walls of the combustor liner 17. While other types of attachment joints and/or methods can be employed, in one possible embodiment the make-up ring 36 is fusion butt welded to the downstream cut edge 33 of the liner wall portion 19. The fusion butt weld may be formed by making a single annular weld about the annular butt joint between the make-up ring and the inner and outer liner walls to which it is abutted.

Although the position of the laser cut made in the combustor liner is selected such as to limit the loss of cooling holes as much as possible (i.e. it may be made in a location of the combustor liner having fewer cooling holes), it may be unavoidable that the cut through the liner wall eliminates some cooling holes. Accordingly, the make-up ring 36 may either be pre-provided with corresponding cooling holes therein, such as to replace those lost due to the cutting process. In another alternative, the cooling holes may be formed in the make-up ring after (instead of before) the make-up ring has been welded in place to at least one of the two combustor portions. This may be accomplished, for example, by drilling the necessary cooling holes into the make-up ring 36.

The length of the make-up ring 36 in an axial direction (i.e. parallel to a longitudinal combustor axis 13, which is itself parallel to a main engine longitudinal axis 11 as shown in FIG. 1) is at least equal to a predetermined length necessary to replace the material lost by the cutting step, with additional allowances made for weld shrinkage. For example, if the laser cut made in the combustor liner 17 to cut the combustor into two portions caused a loss of liner wall material (i.e. the axial length of the cut gap 31) of 0.04 inches and the predetermined weld shrinking for the material of the make-up ring and the liner walls is about 0.01 inches (0.0254 cm) per weld, then the total length of the make-up ring 36 needed is approximately 0.06 inches (0.10668 cm)—namely 0.04 inches (0.1016 cm) to replace the material lost due to the laser cut, plus 0.02 inches (0.0508 cm) which will be lost when the two welds used to attached the make-up ring 36 to the two portions of the disassembled combustor (i.e. at the upstream and downstream cut edges 33 and 35) are made. Once welded in place between the two portions of the cut-apart combustor liner, the final dimensions of the repaired combustor will thus correspond to the dimensions of the combustor prior to the repair. Other dimensions of make-up rings and weld shrinkages are of course possible, and will depend on the geometry of the given combustor, the materials used, the type of weld, etc. However, regardless of the given dimensions, the final axial length Lr of the make-up ring 36 is selected such that, once welded into place between the cut-apart portions of the combustor following the repair process, the combustor 16 has a total axial length L₂ (see FIG. 6) following the repair which is substantially equal to the total axial length L₁ (see FIG. 2) of the combustor 16 prior to the cutting and repair (i.e. L₁=L₂).

If necessary, an additional step of trimming the make-up ring 36 may also be performed prior to making the second weld 40, such that the final axial length prior to making the second weld attachment is the desired final axial length (Lr) to complete the length lost due to the cut and re-weld of the make-up ring, as described above. For example, once the make-up ring 36 has been fixed in place onto a first one of the two combustor portions (such as the downstream liner wall portion 19) by the first weld 38, the final desired axial length of the make-up ring 36 is then determined such that following the second weld the final length of the post-repaired combustor is the same that the length of the combustor prior to the repair process. If this determined final desired axial length of the make-up ring 36 is less than the actual axial length of the make-up ring 36 welded to the first combustor portion (i.e. the make-up ring 36 is longer than necessary), the axial length of the make-up ring 36 is trimmed in order to reduce its length to match the determined final desired length, depicted by line 44 in FIG. 4. The trimming of the make-up ring may be performed by any suitable material removal process, such as cutting, grinding, etc. It is of note that, in addition to the possibility of trimming the make-up ring in order to reduce its axial length, if additional length is in fact required, this made be accomplished by using weld build-up in order to add material as required, in order to ensure that the combustor has a total axial length L₂ following the repair which is substantially equal to the total axial length L₁ prior to the repair.

This trimming step may not be necessary, provided that the desired final axial length Lr of the make-up right exactly corresponds to the length required to re-establish the total axial length of the combustor to its pre-repair dimensional conditions. However, due to the relatively small size of the make-up right which is to be added to the combustor, it may be practically difficult to weld such a narrow ring of material in place between the two portions of the combustor. As such, by initially providing a longer make-up ring 36, and then trimming it down to size once one end has been welded in place to one of the two combustor portions, the positioning and fastening of the make-up ring is generally simplified. It is to be understood, however, that both scenarios (i.e. whether or not the make-up ring is initially size to requiring trimming, or not) are possible.

Using the above-described method installation of the make-up ring, following the cutting of the enclosed one-piece combustor into two portions in order to allow for repair of its internal surfaces, restores the original characteristics of the combustion chamber liner following such repairs. This technique saves cost and processing time by not having to replace the entire dome assembly and/or outer liner, and as such avoids replacing many of the original detail parts of the combustor with the additional reprocessing required to restore thousands of cooling holes. Normally with other one piece CC liners, complete sections are replaced and re-manufactured. Here the introduction of a make-up ring of the same material allows the combustor assembly to be restored to its original dimensional conditions.

The above description is meant to be exemplary only, and one skilled in the art will recognize that changes may be made to the embodiments described without departing from the scope of the invention disclosed. For example, although described and depicted relative to a reverse flow combustor, the described method is similarly applicable to any type of combustor used in a gas turbine engine. This may include, but is not necessarily limited to, combustors made of sheet metal. Further, although the cut made in the combustor liner is depicted as being made proximate the dome portion end of the combustor, it is to be understood that this cut, used simply to divide the combustor into two portions, can be made elsewhere in the annular combustor with similar effect. Additionally, alternate suitable means of fastening (that is other than welding) may also be used to attach the make-up ring to the walls of the combustor liner. Still other modifications which fall within the scope of the present invention will be apparent to those skilled in the art, in light of a review of this disclosure, and such modifications are intended to fall within the appended claims.

1. A method of repairing a one-piece annular reverse-flow combustor of a gas turbine engine, the combustor including a combustor liner having a sheet of metal contiguously defining an inner liner wall extending to a dome wall extending to an outer liner wall, the dome wall provided at an upstream end of the combustor relative to an airflow through the liner, the inner and outer liner walls extending from the dome to a liner exit at a downstream end of the combustor, the method comprising:
opening the combustor by cutting through and around a circumference of at least one of the inner and outer liner walls of the combustor liner to separate the combustor into at least two pieces thereby exposing an internal surface of the combustor, each of the at least two pieces having a cut edge made by said cut;
performing at least one repair operation on the combustor; and
closing the combustor by joining the at least two pieces together, the step of closing including the steps of:
providing an annular sheet metal ring having a size and shape corresponding to the combustor liner in a region of the cut, the ring is provided with a length between first and second ring ends;
welding the first end of the ring to a first one of the at least two combustor pieces the respective cut edge; and
welding the second end of the ring to the other of the at least two combustor pieces at the respective cut edge;
wherein the make-up ring is provided with a length between the first and second ends sufficient to provide the combustor with a desired length after the step of closing is completed.

2. The method as defined in claim 1, wherein the step of cutting comprises cutting the outer liner only.

3. The method as defined in claim 2, wherein the step of cutting comprising cutting the outer liner immediately adjacent the dome wall.

4. The method as defined in claim 1, wherein the step of cutting comprises cutting both the inner liner and the outer liner, such as to separate the combustor into three pieces.

5. The method as defined in claim 1, wherein said desired length of the combustor is substantially equal to an initial axial length of the combustor prior to the step of cutting.

6. The method as defined in claim 1, further comprising, following the step of welding the first end of the ring, trimming the ring to have said ring length.

7. The method as defined in claim 1, wherein the steps of welding further comprise fusion welding the ring to the at least two pieces of the combustor.

8. The method as defined in claim 1, wherein the steps of welding further comprise butt welding the ring to the at least two pieces of the combustor.

9. The method as defined in claim 8, further comprising forming a single annular weld about an annular butt joint between the ring and the at least two pieces of the combustor.

10. The method as defined in claim 1, wherein the step of providing the ring includes providing the ring with material properties corresponding to those of the sheet metal inner and outer liner walls.

11. The method as defined in claim 1, wherein the step of cutting includes selecting a location on the combustor liner for making the cut that is substantially free of cooling holes.

12. The method as defined in claim 1, wherein the step of performing at least one repair operation on the combustor includes performing at least one of a weld repair step, a coating restoration step and a crack repair step on the combustor.

13. The method as defined in claim 1, wherein the step of cutting t includes using a laser to perform the cut.

14. A method of re-establishing original dimensional characteristics of a one-piece annular gas turbine combustor that has been cut into at least two combustor portions for repair purposes, the method comprising the steps of:
providing an annular make-up ring having a size and shape corresponding to the combustor liner;
welding a first end of the make-up ring to a first one of the two combustor portions at a location of the cut made therein;
ensuring the make-up ring has a predetermined axial length between said first end and a second end of the make-up ring; and
welding the second end of the make-up ring to the other one of the two combustor pieces at the location of the cut made therein; and
wherein the predetermined axial length of the make-up ring is selected such that an overall axial length of the combustor after the step of welding the second end of the make-up ring to the combustor liner is substantially equal to an original overall length of the combustor before the repair.

15. The method as defined in claim 14, wherein the step of ensuring further comprises measuring an actual axial length of the make-up ring, and trimming the make-up ring until the actual axial length thereof corresponds to said predetermined axial length.

16. The method as defined in claim 14, wherein the steps of welding further comprise fusion welding the make-up ring to the two combustor portions.

17. The method as defined in claim 14, wherein the steps of welding further comprise butt welding the make-up ring to the two combustor portions.

18. The method as defined in claim 15, further comprising forming a single annular weld about an annular butt joint between the make-up ring and the combustor liner.

19. The method as defined in claim 14, wherein the combustor liner is composed of sheet metal, the step of providing the make-up ring including providing a make-up ring having material properties corresponding to those of the sheet metal combustor liner.
